(19) United States
(12) Patent Application Publication
(10) Pub. No.: US 2013/0032522 A1
(43) Pub. Date: Feb. 7, 2013

(54) MONO REMOTE FILTER PLATFORM SYSTEM. RELATES TO AN APPARATUS AND METHOD OF MOUNTING A REMOTE FILTER BASE AND FILTER TO AN INTERNAL COMBUSTION ENGINE. SYSTEM PROVIDES FOR REMOTE MOUNTING METHOD AND DEVICE THAT FASTENS TO ENGINE BLOCK. SYSTEM INCLUDES A METHOD FOR SUPPORT OF THE REMOTE FILTER BASE AND FILTER UTILIZING A SINGLE ARM STRUT AND PLATFORM PLATE.

(71) Applicant: Kim Eugene Mallett, Independence, MO (US)

(72) Inventor: Kim Eugene Mallett, Independence, MO (US)

(21) Appl. No.: 13/564,714

(22) Filed: Aug. 1, 2012

Related U.S. Application Data
(60) Provisional application No. 61/514,900, filed on Aug. 4, 2011.

(51) Int. Cl. B01D 35/02

(52) U.S. Cl. 210/232

(57) ABSTRACT

An improved remote mounting system for attachment of oil filter bases to an engine. The system is constructed as structural support for a single metal beam holding a platform for common oil filter bases and their filters to attach. In addition the system provides the mounting device with the purpose to remote mount oil filter mounting bases and their filters in locations previously not usable or accessible.

Other embodiments are described and shown.

### CROSS-REFERENCE TO RELATED APPLICATIONS

This application claims the benefit of provisional patent application Ser. No. 61/514,900 filed 2011 Aug. 4 by the present inventor.

### BACKGROUND

### Prior Art

U.S. Patents

| Pat. No. | Kind Code | Issue Date | Patentee |
|---|---|---|---|
| 4,290,397 | | Sep. 22, 1981 | Sorsche, Ableitner, |
| | | | Gobien, Minning |
| 4,697,782 | | Oct. 6, 1987 | Ban |
| 5,743,358 | | Apr. 28, 1998 | Bedi, van der Griendt |

U.S. Patent Application Publications

| Publication Nr. | Kind Code | Publ. Date | Applicant |
|---|---|---|---|
| 2009/0,159,038 | A1 | Jun. 25, 2009 | Koyama, Hori, Matsui |

### BACKGROUND OF THE INVENTION

Remote mounted oil filter bases are commonly deployed for the purpose of moving the oil filter to a convenient location on an internal combustion engine. This remote filter platform makes it possible to locate a remote filter base in locations where the base alone would not fit or attach to an engine. The benefit is evident when there is no room to mount a filter base but with the use of the remote filter platform a previously unusable location can be utilized. Filter bases are available in a variety of configurations for different vendors. Many could utilize the remote filter platform for relocation of a standard filter base to a difficult to use space.

### DESCRIPTION OF PRIOR ART

Many remote mounts have been produced that allow connectivity of remotely located secondary oil filtration devices. The predominant method used connects the adapter base in a stationary position. All remote filtration mounts heretofore are known to suffer from a number of disadvantages:
(a) Oil filter mounting bases mount directly to the engine block
(b) Space limitations
(b) Traditional mounting bases allow very limited adjustment of position.
(b) Common remote filter mounts simply move the mounting location
(c) Other systems rely on common oil filter mounting devices

### Advantages

Several advantages of one or more aspects are as follows: Use without modification to the engine, common filter bases mount to this mount, space requirement is small allowing alternative open space away from the engine to be used for common filter base. Other advantages of one or more aspects will be apparent from a consideration of the drawings and description.

### BRIEF DESCRIPTION OF DRAWINGS

FIG. 1A is a view of the mono remote filter platform assembly including a conventional remote filter base and filter according to the present invention

FIG. 1B is an exploded view of the mono remote filter platform assembly

### DRAWINGS

### Reference Numerals

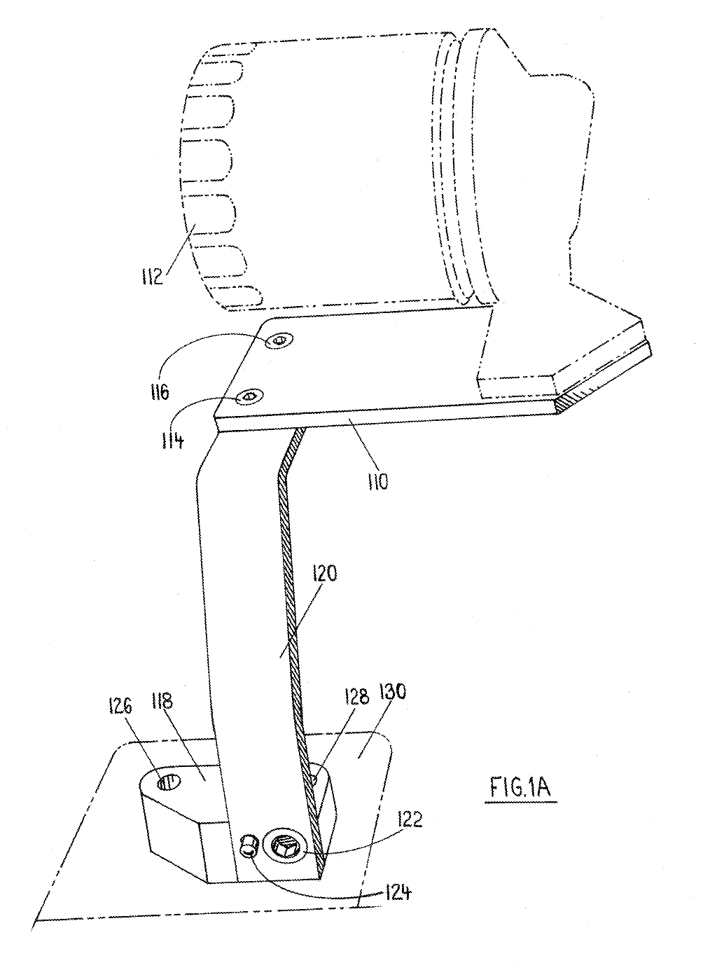

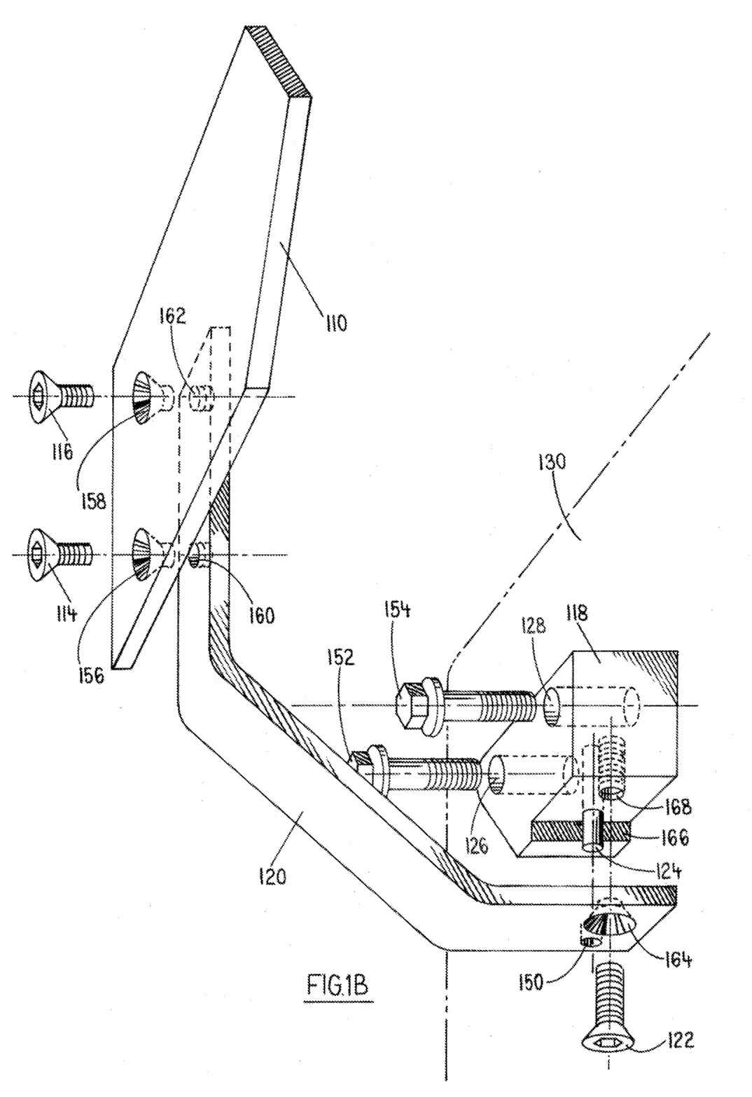

See accompanying drawings.

| | |
|---|---|
| Drawing Reference Numerals | Drawing 2/2 |
| Drawing 1/2 | FIG. 1B— |
| FIG. 1A— | 150 Conventional Hardened Steel Pin Clearance |
| 110 Mono Remote Filter Platform Plate | Hole |
| 112 Conventional Remote Filter Base and Filter | 152 Conventional Flange Bolt One |
| 114 Conventional Flathead Socket Bolt One | 154 Conventional Flange Bolt Two |
| 116 Conventional Flathead Socket Bolt Two | 156 Platform Plate Chamfer One |
| 118 Mono Mounting Block | 158 Platform Plate Chamfer Two |
| 120 Mono Platform Arm | 160 Threaded Hole One |
| 122 Large Conventional Flathead Socket Bolt | 162 Threaded Hole Two |
| 124 Conventional Hardened Steel Pin | 164 Large Flathead Chamfer |
| 126 Mono Mounting Block Bolt Hole One | 166 Mono Platform Arm Support Step |
| 128 Mono Mounting Block Bolt Hole Two | 168 Threaded Large Flathead Mounting Hole |
| 130 Engine Block | |

### Description of Preferred Embodiment

The apparatus of the present invention is depicted schematically in FIGS. 1A and 1B and contains one primary device in the remote filter and base platform assembly.

As seen in FIG. 1A the device is comprised of the aggregate of the following, starting with mono remote filter platform plate 110 being held to the mono platform arm 120 by conventional flathead socket bolt one 114 and conventional flathead socket bolt two 116. Mono mounting block 118 and associated large conventional flathead socket bolt 122 and conventional hardened steel pin 124 attach said mono arm 120 and assembly to engine block 130. Said attachment is facilitated by mono mounting block bolt hole one 126 and mono mounting block bolt hole two 128 using conventional flange bolt one 152 (FIG. 1B) and conventional flange bolt two 154 (FIG. 1B). The apparatus provides a mounting platform for conventional remote filter base and filter 112.

In FIG. 1B it can be seen that the conventional flange bolt one 152 and conventional flange bolt two 154 engage into threads through mono mounting block bolt hole one 126 (FIG. 1A) and mono mounting block bolt hole two 128 (FIG. 1A) affixing the apparatus to engine block 130 (FIG. 1A). Referring to FIG. 1B the exploded view shows the fastening method for mono remote filter platform plate 110 (FIG. 1A) to mono platform arm 120 (FIG. 1A). The conventional flathead bolt one 114 (FIG. 1A) and conventional flathead bolt two 116 (FIG. 1A) insert through platform plate chamfer one 156 and platform plate chamfer two 158 to threaded hole one 160 and threaded hole two 162 to complete said fastening method.

In addition FIG. 1B illustrates engagement of large conventional flathead socket bolt 122 (FIG. 1A) through large flathead chamfer 164 to threaded large flathead mounting hole 168. Mono platform arm support step 166 and conventional hardened steel pin clearance hole 150 provide a tight fit for conventional hardened steel pin 124 (FIG. 1A) and mono platform arm 120 (FIG. 1A) to mono mounting block 118 (FIG. 1A) when large conventional flathead socket bolt 122 (FIG. 1A) is tightened.

### Features and Operation

The present invention relates to an apparatus separate from an internal combustion engine. The external device as part of said invention provides a method for fastening a conventional remote filter base and filter 112 to said engine. The function provides a method for filter base and filter 112 to be mounted to mono remote filter platform plate 110 by way of additional fasteners dependent on the characteristics of the specific filter base and filter 112 chosen. Remote filter plate 110 is then secured to mono platform arm 120 by way of conventional flathead socket bolt one 114 and conventional flathead socket bolt two 116 inserted through platform plate chamfer one 156 and platform plate chamfer two 158 into threaded hole one 160 and threaded hole two 162.

Platform arm 120 and conventional hardened steel pin clearance hole 150 locate onto conventional hardened steel pin 124 and against mono platform arm support step 166. Once in place mono platform arm 120 secures to mono mounting block 118 via large conventional flathead socket bolt 122 through large flathead chamfer 164 into threaded large flathead mounting hole 168.

The final securing method used is flange bolt one 152 through mounting hole one 126 and flange bolt two 154 through mounting hole two 128 securing the entire assembly to engine block 130.

### Conclusion, Ramifications, and Scope

Thus the reader will see that the embodiment of the mono remote filter platform assembly provides an apparatus, methods and device facilitating the mounting of conventional remote filter bases and filters to internal combustion engines. Some of the unique features being the mono platform arm, the method of attachment to the mono mounting block and then to the engine block.

While my above description contains many specificities, these should not be construed as limitations on the scope, but rather as an exemplification of one embodiment thereof. Many other variations are possible.
For example a variety of conventional remote filter bases and filters can attach to the remote filter platform plate assembly.
The platform plate 110 and mounting block 118 can be created from a variety of materials or changed in size to still perform the same function.
Color of components is not a factor. Shapes can vary as well.
Conventional flange bolts 152 and 154, conventional bolts 114 and 116, and conventional bolt 122 can vary in material of construction and configuration of overall size, length, and thread specification.
Steel pin 124 can vary in overall size, length and specification.
Platform arm 120 can vary in material of construction and configuration of overall size and length though consideration must be given as this is the primary structural member supporting platform plate 110 and conventional base and filter 112.

What is claimed is:

1. A remote filter base mounting platform comprising:
a. means for attaching a conventional remote filter base and filter as a unit to an engine block without direct attachment of said filter base to engine block.
b. means for attachment of a remote filter platform using a single support arm
c. means of construction of the single strut platform mounting block and assembly utilizing the machined boss and hardened steel pin.
d. means for attachment of remote filter bases in previously unusable location away from engine.
